(19) United States
(12) Patent Application Publication
(10) Pub. No.: US 2023/0069742 A1
(43) Pub. Date: Mar. 2, 2023

(54) GAZED BASED GENERATION AND PRESENTATION OF REPRESENTATIONS

(71) Applicant: TOYOTA MOTOR ENGINEERING & MANUFACTURING NORTH AMERICA, INC., Plano, TX (US)

(72) Inventor: John C. Rafferty, Dexter, MI (US)

(73) Assignee: TOYOTA MOTOR ENGINEERING & MANUFACTURING NORTH AMERICA, INC., Plano, TX (US)

(21) Appl. No.: 17/459,143

(22) Filed: Aug. 27, 2021

(51) Int. Cl. G06F 3/01; G06F 3/0481; G06F 3/0488; B60R 1/00; B60R 11/04

(52) U.S. Cl. CPC G06F 3/013; G06F 3/04817; G06F 3/0488; B60R 1/00; B60R 11/04; B60R 2011/004

(57) ABSTRACT

A method for granting access to vehicle functionalities is provided. The method includes receiving a signal from a device that is external to the vehicle, the signal including identification data of an object associated with the device, comparing the identification data with user identifications stored in the memory of the vehicle, and granting, to the object, access to a first set of functionalities of the vehicle in response to determining that the identification data matches a first user identification of the user identifications stored in the memory of the vehicle.

### TECHNICAL FIELD

The embodiments described herein generally relate to presenting an representation of one or more input devices, and more specifically, to generating a representation of one or more input devices located in a vehicle and presenting the representation on or in association with one or more surfaces of the vehicle.

### BACKGROUND

Conventional vehicle systems include various components that may be controlled via various forms of user interaction such as physical contact, gestures, speech based control, and so forth. For example, passengers seated in vehicles may be able to access and control various vehicle operations by interacting with a head unit located in the front of the vehicle. However, individuals seated in areas within the vehicle from where the head unit of the vehicle or other components are not easily accessible may not be able control any vehicle operations.

Accordingly, a need exists for alternative systems that enable passengers that are seated in areas within the vehicle from where various vehicle components are easily accessible, e.g., not within arm's reach, to nonetheless effectuate control over various vehicle operations.

### SUMMARY

In one embodiment, a method for presenting a representation of one or more input devices on a surface is provided. The method includes detecting, using a sensor operating in conjunction with the computing device of the vehicle, a gaze of a user relative to one or more input device positioned in an interior of the vehicle and presenting a representation of the one or more input devices on a surface of the vehicle that is adjacent to the user.

In another embodiment, a vehicle for presenting a representation of one or more input devices on a surface of the vehicle is provided. The vehicle includes a sensor, an additional sensor, and a computing device that is communicatively coupled to the sensor and the additional sensor. The computing device is configured to detecting, using the sensor operating in conjunction with the computing device of the vehicle, a gaze of a user relative to one or more input devices positioned in an interior of the vehicle, and presenting a representation of the one or more input devices on a surface of the vehicle that is adjacent to the user.

In another embodiment, a vehicle for presenting a representation of a location that is external to the vehicle is provided. The vehicle includes a sensor, an additional sensor, an image capture device positioned on an exterior portion of the vehicle, and a computing device that is communicatively coupled to each of the sensor, the additional sensor, and the image capture module. The computing device is configured to detect, using the sensor, a gaze of a user relative to a location that is external to the vehicle, capture, using the image capture device, a real-time video stream of the location that is external to the vehicle, and present, on a surface of the vehicle that is adjacent to the user, a representation of the location that is included in the real-time video stream.

These and additional features provided by the embodiments described herein will be more fully understood in view of the following detailed description, in conjunction with the drawings.

### BRIEF DESCRIPTION OF DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a representation generating environment that is configured to generate a representation and present the representation of one or more input devices on or in association with one or more surfaces of a vehicle, according to one or more embodiments described and illustrated herein;

FIG. 2 depicts non-limiting components of the devices of the present disclosure, according to one or more embodiments described and illustrated herein;

FIG. 3A depicts a flow chart for presenting a representation of one or more input devices of the vehicle on a surface of the vehicle, according to one or more embodiments described herein;

FIG. 3B depicts a flowchart for training an artificial intelligence neural network model to determine a target action intended to be performed by the passenger 108, according to one or more embodiments described and illustrated herein;

FIG. 4A depicts an example operation of the representation presentation system as described in the present disclosure, according to one or more embodiments described and illustrated herein;

FIG. 4B depicts an example representation of the example head unit on a window of the vehicle, according to one or more embodiments described and illustrated herein;

FIG. 4C depicts an example representation of the example head unit on a mobile device of the passenger, according to one or more embodiments described and illustrated herein;

FIG. 5 depicts a flow chart for presenting an representation of one or locations external to the vehicle on a surface of the vehicle, according to one or more embodiments described herein;

FIG. 6A depicts an example operation of the representation presentation system of the present disclosure in which an representation of a location exterior to the vehicle may be presented on the window of the vehicle, according to one or more embodiments described and illustrated herein;

FIG. 6B depicts an example representation of an external location at which the passenger 108 may have gazed being presented on the window of the vehicle, according to one or more embodiments described and illustrated herein; and

FIG. 6C depicts the example representation of an external location at which the passenger may have gazed being presented on the mobile device of the passenger, according to one or more embodiments described and illustrated herein.

### DETAILED DESCRIPTION

The embodiments disclosed herein describe systems and methods for generating and presenting one or more representations of one or more input devices included within a vehicle and/or of one or more locations that are external to the vehicle. In particular, these representations may be presented on one or more surfaces in the interior of the vehicle, e.g., windows. Additionally, in embodiments, the representations may be displayed or presented as part of a virtual or augmented reality environment such that the representations appear to emerge outwards from various surfaces within the vehicle, e.g., an arm rest, empty back seat, or floor of the vehicle. In embodiments, the representations, after emerging from one or more of these surfaces, may appear at a certain height and within arm's length of a passenger such that the passenger may easily interact with one or more of a plurality of interactive icons included as part of the representation. In embodiments, based on the interaction of the passenger with the one or more interactive icons, one or more operations of the vehicle may be controlled, e.g., climate control, audio control, and so forth. For example, the representation of a head unit of a vehicle may be generated and presented on a rear-passenger window adjacent to a passenger seated in the rear passenger seat of the vehicle. The passenger may then select an interactive icon associated with climate control of the vehicle and set a temperature within the vehicle.

Additionally, in embodiments physical switches or buttons may be embedded within various parts of a vehicle, e.g., rear seats of the vehicle, portions of the interior of the rear doors of the vehicle, and so forth. In embodiments, upon activation, these embedded physical switches may protrude from their respective embedded locations and deform the material within which these switches are embedded, e.g., leather seats, portions of the rear passenger doors, and so forth. The users may interact with these switches, by contacting these switches with the hands, and control one or more vehicle operations.

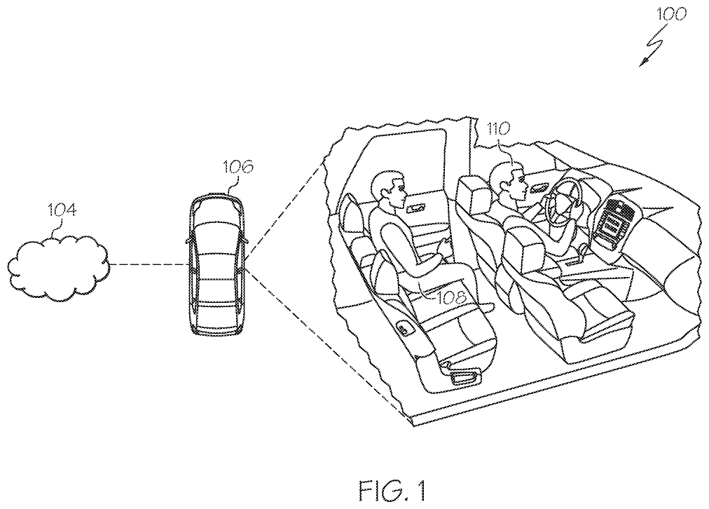

Referring to the drawings, FIG. 1 schematically depicts a representation generating environment 100 that is configured to generate a representation and present the representation of one or more input devices on or in association with one or more surfaces of a vehicle 106, according to one or more embodiments described and illustrated herein. The representation generating environment 100 may include a vehicle 106 that may have a passenger 108 and a driver 110 seated therein. The driver 110 is seated in the driver's seat and the passenger 108 is seated in one of the back seats. The vehicle 106 may include a head unit with a touch screen display with which the driver 110 and passengers may interact in order to control various vehicle functions such as, e.g., climate control, audio control, and so forth. The head unit may be positioned within a certain distance from a front seat of the vehicle 106. For example, the head unit may be positioned within 200-300 centimeters from the steering wheel and/or approximately 1 foot away from the driver's seat or the passenger's seat.

In embodiments, the passenger 108 seated in the back seat of the vehicle 106 may direct his gaze towards the head unit and maintain the gaze for a predetermined time frame. In response, one or more processors of the vehicle 106 may generate a representation of the head unit or a portion of the head unit, in additional to the digital content that is displayed on the head unit at a particular point in time (e.g., the point in time at which the gaze of the user is directed towards the head unit), and present or output the generated representation of the head unit on one or more surfaces within the interior of the vehicle 106. For example, the representation may be presented or output on a window that is adjacent to the passenger 108. Additionally, in embodiments, the representation may morph from or appear as part of a virtual or augmented reality based environment. For example, the representation may appear as emerging from a back seat that is adjacent to a seat upon which the passenger 108 is seated. The passenger 108 may interact such a representation and be able to control various features within the vehicle, e.g., climate conditions, stereo, and so forth. It is noted that the head unit is positioned in an area adjacent to the steering wheel (e.g., an additional surface) that is not easily accessible to the passenger 108, e.g., not within arm's reach of the passenger 108. In embodiments, within arm's reach may refer to a value in the range of 50 centimeters to 100 centimeters. Additionally, the phrase “adjacent” as described in the present disclosure may also refer to a distance between 20 centimeters to 100 centimeters.

In other embodiments, one or more input devices or switches may emerge from underneath the seat of the passenger 108 or from a seat that is next to the seat in which the passenger 108 is seated. These input devices or switches may be flexible and embedded into the rear seats and other areas in the interior of the vehicle 106 (e.g., rear doors). These input devices may automatically emerge from these areas and the passenger 108 may interact with these switches or input devices by contacting one or more portions on the exterior of these switches and input devices. Subsequent to such an interaction, one or more operations of the vehicle 106 may be controlled. It is noted that when one or more input devices or switches are activated, these switches may protrude outward from a default position. The passenger 108 may contact the exterior portions of these switches and control one or more vehicle operations or functions.

In other embodiments, as stated above, a representation that is generated based on locations at which the gaze of the passenger 108 is directed may be based on a portion of the head unit at which the passenger 108 may have directed his gaze. In embodiments, if the passenger 108 directed his gaze to a specific interactive icon displayed on the head unit for a predetermined time frame, the representation may be generated to include only the specific interactive icon. For example, if the passenger 108 gazes at an interactive icon for controlling the climate within the vehicle 106, the generated representation may be only of, e.g., the climate control interactive icon. In embodiments, a representation of the climate control interactive icon may be presented on a rear window that is next to the seat at which the passenger 108 is seated.

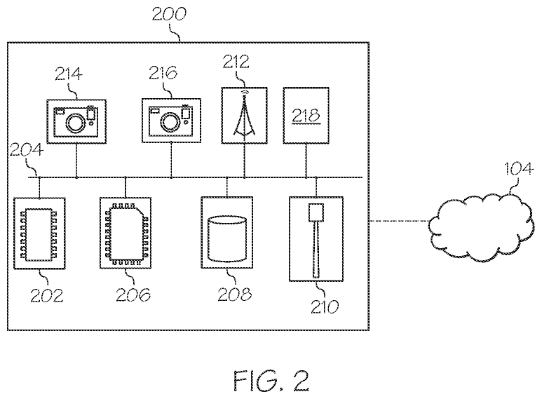

FIG. 2 depicts non-limiting components of the devices of the present disclosure, according to one or more embodiments described and illustrated herein. While the vehicle system 200 is depicted in isolation in FIG. 2, the vehicle system 200 may be included within a vehicle. For example, the vehicle system 200 may be included within the vehicle 106 illustrated in FIG. 1. The vehicle 106 may be an automobile or any other passenger or non-passenger vehicle such as, for example, a terrestrial, aquatic, and/or airborne vehicle. In embodiments in which the vehicle system 200 is included within the vehicle 106, such a vehicle may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

In embodiments, the vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

In the vehicle system 200, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like. Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206.

Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In some embodiments, the one or more memory modules 206 may store data related to user actions performed with respect to various components and devices within the vehicle 106. For example, the memory modules 206 may store position data associated with one or more locations within the vehicle 106 that the passenger 108 may have contacted. The memory modules 206 may also store user action data associated with a plurality of additional users that may performed actions with other vehicle, e.g., vehicles that are external to the vehicle 106.

Referring still to FIG. 2, the vehicle system 200 comprises one or more sensors 208. Each of the one or more sensors 208 is coupled to the communication path 204 and communicatively coupled to the one or more processors 202. The one or more sensors 208 may include one or more motion sensors for detecting and measuring motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle. In embodiments, the sensors 208 may also include motion sensors and/or proximity sensors that are configured to detect road agents and movements of road agents (e.g., pedestrians, other vehicles, etc.) within a certain distance from these sensors. It is noted that data from the accelerometers may be analyzed the one or more processors 202 in conjunction with the obtained from the other sensors to enable control of one or more operations of the vehicle 106.

Referring to FIG. 2, the vehicle system 200 comprises a satellite antenna 210 coupled to the communication path 204 such that the communication path 204 communicatively couples the satellite antenna 210 to other modules of the vehicle system 200. The satellite antenna 210 is configured to receive signals from global positioning system satellites. Specifically, in one embodiment, the satellite antenna 210 includes one or more conductive elements that interact with electromagnetic signals transmitted by global positioning system satellites. The received signal is transformed into a data signal indicative of the location (e.g., latitude and longitude) of the satellite antenna 210 or an object positioned near the satellite antenna 210, by the one or more processors 202.

Still referring to FIG. 2, the vehicle system 200 comprises network interface hardware 212 (e.g., a data communication module) for communicatively coupling the vehicle system 200 to various external devices, e.g., remote servers, cloud servers, etc. The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In embodiments, the network interface hardware 212 (e.g., a data communication module) may receive data related to user actions performed by various users associated with vehicles that are external to the vehicle 106. In embodiments, the network interface hardware 212 may utilize or be compatible with a communication protocol that is based on dedicated short range communications (DSRC). In other embodiments, the network interface hardware 212 may utilize or be compatible with a communication protocol that is based on vehicle-to-everything (V2X). Compatibility with other communication protocols is also contemplated.

Still referring to FIG. 2, the vehicle system 200 includes an outward facing camera 214. The outward facing camera 214 may be installed on various portions on the exterior of the vehicle 106 such that this camera may capture one or more images or a live video stream of stationary and moving objects (e.g., road agents such as pedestrians, other vehicles, etc.) within a certain proximity of the vehicle 106. The outward facing camera 214 may be any device having an array of sensing devices capable of detecting radiation in an ultraviolet wavelength band, a visible light wavelength band, or an infrared wavelength band. The camera may have any resolution. In some embodiments, one or more optical components, such as a mirror, fish-eye lens, or any other type of lens may be optically coupled to the camera. In embodiments, the outward facing camera 214 may have a broad angle feature that enables capturing digital content within a 150 degree to 180 degree arc range. Alternatively, the outward facing camera 214 may have a narrow angle feature that enables capturing digital content within a narrow arc range, e.g., 60 degree to 90 degree arc range. In embodiments, the outward facing camera 214 may be capable of capturing standard or high definition images in a 720 pixel resolution, a 1080 pixel resolution, and so forth. Alternatively or additionally, the outward facing camera 214 may have the functionality to capture a continuous real time video stream for a predetermined time period.

Still referring to FIG. 2, the vehicle system 200 includes an inward facing camera 216 (e.g., an additional camera). The inward facing camera 216 may be installed within an interior of the vehicle 106 such that this camera may capture one or more images or a live video stream of the drivers and passengers within the vehicle 106. In embodiments, the one or more images or a live video stream that is captured by the inward facing camera 216 may be analyzed by the one or more processors 202 to determine the orientation of the heads, eyes, etc., of the drivers and passengers in relation to one or more objects in the interior of the vehicle 106. As stated, the inward facing camera 216 may be positioned on the steering wheel, dashboard, head unit, or other locations that have a clear line of sight of passengers seated, e.g., in the front seat and the back seat of the vehicle 106. The inward facing camera 216 may have a resolution level to accurately detect the direction of the gaze of a passenger relative to various components within the vehicle 106.

The inward facing camera 216 may be any device having an array of sensing devices capable of detecting radiation in an ultraviolet wavelength band, a visible light wavelength band, or an infrared wavelength band. The camera may have any resolution. In some embodiments, one or more optical components, such as a mirror, fish-eye lens, or any other type of lens may be optically coupled to the camera. In embodiments, the inward facing camera 216 may have a broad angle feature that enables capturing digital content within a 150 degree to 180 degree arc range. Alternatively, the inward facing camera 216 may have a narrow angle feature that enables capturing digital content within a narrow arc range, e.g., 60 degree to 90 degree arc range. In embodiments, the inward facing camera 216 may be capable of capturing standard or high definition images in a 720 pixel resolution, a 1080 pixel resolution, and so forth. Alternatively or additionally, the inward facing camera 216 may have the functionality to capture a continuous real time video stream for a predetermined time period.

Still referring to FIG. 2, the vehicle system 200 may include a projector 218 that is configured to project or enable presentation of digital content (e.g., images, live video stream, and so forth) on various surfaces within the vehicle 106. In embodiments, the projector 218 may be communicatively coupled to the one or more processors 202 via the communication path 204. In embodiments, multiple projectors that are comparable to the projector 218 may be positioned at various locations on the interior of the vehicle 106 and each of these projectors may also be communicatively coupled to the one or more processors 202 via the communication path 204. The projector 218 may receive instructions from the one or more processors 202 to project digital content on various interior surfaces of the vehicle 106 for predetermined time frames. In embodiments, the projector 218 may be positioned on the rear doors of the vehicle 106 at an angle of 45 degrees such that the projector 218 projects digital content directly on the rear windows of the vehicle 106. It should be understood that display devices other than projectors may be utilized.

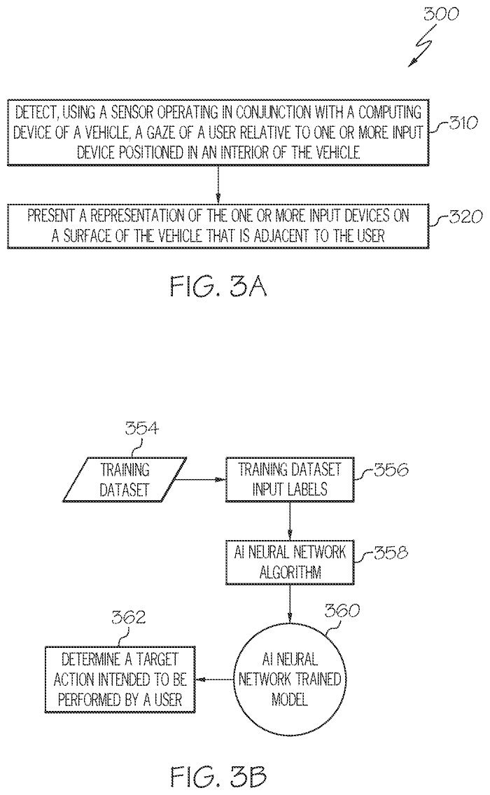

FIG. 3A depicts a flow chart 300 for presenting a representation of one or more input devices of the vehicle 106 on a surface of the vehicle 106, according to one or more embodiments described herein. At block 310, one or more sensors operating in conjunction with a computing device (e.g. one or more processors of an electronic control unit within the vehicle 106) may detect a gaze of a user relative to one or more input devices positioned in an interior of the vehicle 106. For example, the one or more sensors may be the inward facing camera 216, which may be positioned at various locations in the interior of the vehicle 106. For example, the inward facing camera 216 may be positioned at a location that may be within a direct line of sight of the passenger 108. In embodiments, the inward facing camera 216 may be positioned on a head unit mounted above the gear box and adjacent to the steering wheel of the vehicle 106.

In embodiments, the inward facing camera 216 may capture image data (e.g., one or more images) or a live video stream of various aspects of the passenger 108 seated in a rear seat of the vehicle 106. For example, the inward facing camera 216 may capture one or more images or a live video stream of an orientation of a head of the passenger 108, in additional to tracking the movement of the eyes of the passenger 108. In embodiments, the inward facing camera 216 may be positioned on or in close proximity to the head unit of the vehicle 106, while another camera may be positioned on the window 406 (e.g., a rear seat window) of the vehicle 106 and configured to capture additional images or a live video stream of the head orientation of the passenger 108 and the orientation of the eyes of the passenger 108.

The one or more processors 202 may receive image data from the inward facing camera 216 (among any additional cameras) and analyze the image data to determine one or more locations within the vehicle 106 at which the passenger 108 may have gazed. In embodiments, the one or more processors 202 may utilize an artificial intelligence neural network trained model to perform such a determination. In embodiments, the one or more processors 202 may analyze the image data and identify one or more input devices upon which the passenger 108 (seated in the back seat) may have gazed. For example, the one or more processors 202 may determine that the passenger 108 gazed at one or more physical switches, e.g., physical switches for activating (e.g., turning on) or deactivating (turning off) a sound system of the vehicle 106, climate controls switches of the vehicle 106, and so forth. Additionally, in embodiments, the one or more processors 202 may determine that the passenger 108 gazed at various portions of the head unit within the vehicle. These portions may include a display of the head unit upon which one or more interactive icons may be displayed. The interactive icons may enable the control of various components of the vehicle 106, e.g., climate control, sound system, and so forth. Additionally, interacting with these icons may enable passengers to make and answer phone calls, send text messages, access various types of digital content, e.g., songs, movies, and so forth.

In embodiments, upon analyzing the image data, if the one or more processors 202 determine that the passenger 108 seated in the back seat has gazed at a particular input device for a predetermined time frame (e.g., 1 second, 2 seconds, 3 seconds, etc.), the one or more processors 202 may generate a representation of the particular input device. For example, if the one or more processors 202 determine that the passenger 108 has viewed a climate control interactive icon for a predetermined time frame, the one or more processors 202 may generate a representation, in real time, which may be at least a portion of the head unit that includes the climate control interactive icon, among other interactive icons.

At block 320, the one or more processors 202 may present a representation of the one or more input devices on a surface of the vehicle 106 that is positioned adjacent to the user. The one or more processors 202 may output the generated representation corresponding to the climate control interactive icon output on the head unit on one or more surfaces on the inside of the vehicle. For example, the generated representation may have the shape and dimensions of the head unit on which the climate control icon may be presented on a rear seat window that is adjacent to the passenger 108 seated in the back seat in real time. In embodiments, the representation may appear as an interactive image of the display of the physical head unit positioned near the driver's seat, which is not easily accessible for the passenger 108. The passenger 108 may be able to select an interactive graphical icon within the interactive graphical. Based on the selection, the passenger 108 may be able to modify climate conditions within the vehicle 106. In other embodiments, the representation may morph from or appear as part of a virtual or augmented reality based environment. For example, the representation may appear as emerging from a back seat that is adjacent to a seat upon which the passenger 108 is seated. The passenger 108 may interact with such a representation and be able to control various features within the vehicle 106, e.g., climate conditions, stereo, and so forth.

FIG. 3B depicts a flowchart for training an artificial intelligence neural network model to determine a target action intended to be performed by the passenger 108, according to one or more embodiments described and illustrated herein. As illustrated in block 354, a training dataset may include training data in the form of user gaze tracking data, image data, video stream data, location data associated with various components within vehicles and various areas that are external to these vehicles. Additionally, in embodiments, all of such data may be updated in real time and stored in the one or more memory modules 206 or in databases that are external to these vehicles.

In blocks 356 and block 358, an artificial intelligence neural network algorithm may be utilized to train a model on the training dataset with the input labels. As stated, all or parts of the training dataset may be raw data in the form of images, text, files, videos, and so forth, that may be processed and organized. Such processing and organization may include adding dataset input labels to the raw data so that an artificial intelligence neural network based model may be trained using the labeled training dataset.

One or more artificial neural networks (ANNs) used for training the artificial intelligence neural network based model and the artificial intelligence neural network algorithm may include connections between nodes that form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error.

In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling.

Additionally, one or more ANN models may be utilized to generate results as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

In some embodiments, a convolutional neural network (CNN) may be utilized. For example, a CNN may be used as an ANN that, in a field of machine learning, for example, is a class of deep, feed-forward ANNs that may be applied for audio-visual analysis. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture. Upon adequately training the artificial intelligence neural network trained model, the embodiments may utilize this model to perform various actions.

Specifically, in blocks 360 and 362, the one or more processors 202 may utilize the artificial neural network trained model to analyze user gaze tracking data, image data, video stream data, and location data to determine a target action intended to be performed by a user. For example, the one or more processors 202 may utilize the artificial intelligence neural network trained model to compare, e.g., gaze data of a user with those of other users, and determine based on the comparison that a particular user (e.g., the passenger 108) intended to interact with a head unit positioned within a vehicle. It should be understood that embodiments are not limited to artificial intelligence based methods of determining a user's intended target action.

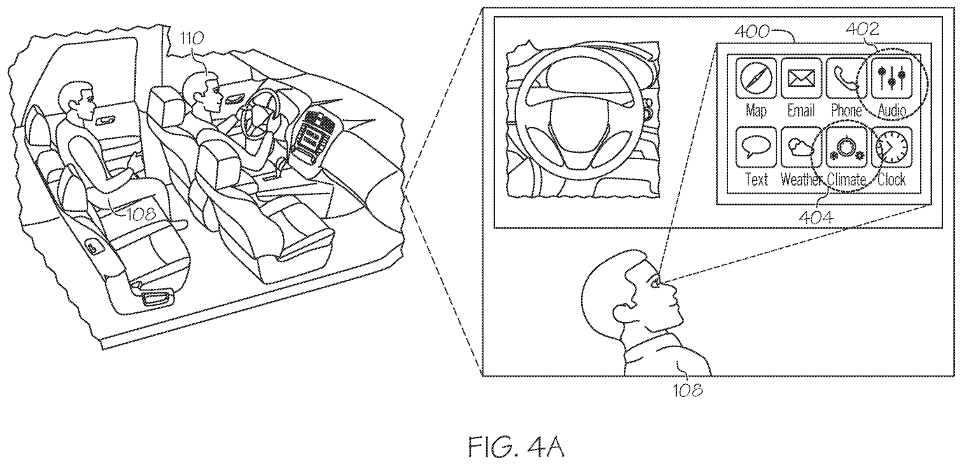

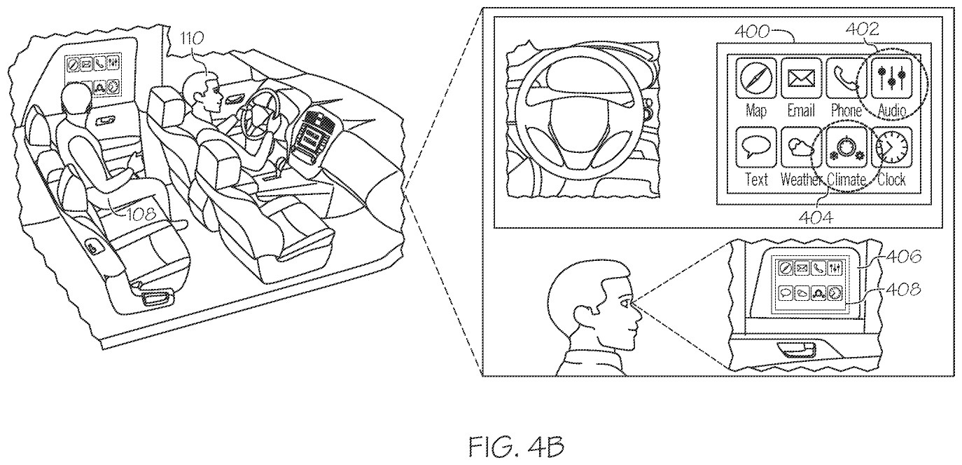

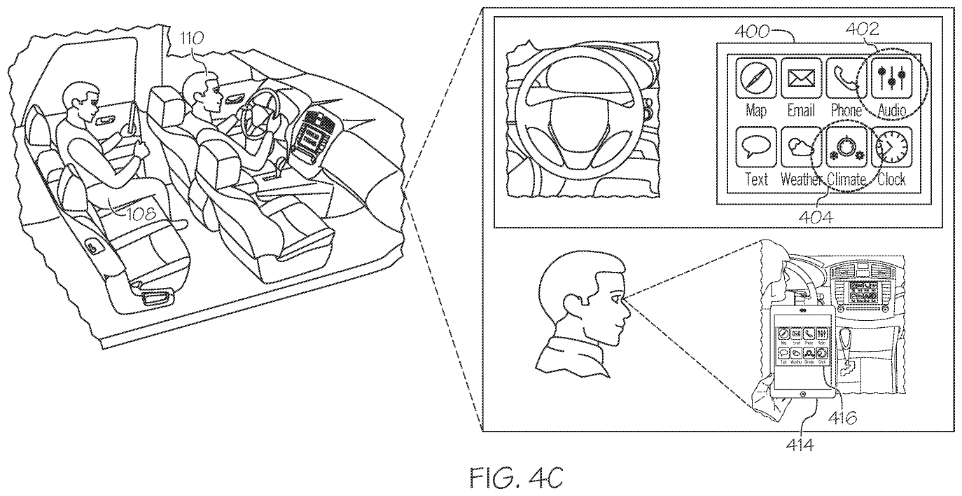

FIG. 4A depicts an example operation of the representation presentation system as described in the present disclosure, according to one or more embodiments described and illustrated herein. In particular, in FIG. 4A, the passenger 108 may enter the vehicle 106, sit in the back seat, and direct his gaze towards an example head unit 400 positioned adjacent to the steering wheel of the vehicle 106. The inward facing camera 216 may track the movements of the head of the passenger 108 over a certain time frame and determine areas in the interior of the vehicle 106 that the passenger 108 may view. Additionally, the inward facing camera 216 may capture image data associated with the head movement and areas viewed by the passenger 108 and route this image data, in real time, to the one or more processors 202 for analysis.

The one or more processors 202 may analyze the image data and determine that the passenger 108 has viewed specific interactive graphical icons 402 and 404 displayed on the example head unit 400. In embodiments, the one or more processors 202 analyze the image data to determine that the gaze of the passenger 108 may be associated with interactive graphical icons 402 and 404 for a predetermined time frame, e.g., 50 milliseconds, 1 second, 2 seconds, and so forth. In response, in embodiments, the one or more processors 202 may generate an example interactive representation of the example head unit 400, in addition to generating instructions for outputting or presenting the representation on a window of the vehicle 106, e.g., adjacent to the rear seat where the passenger 108 is seated, or on any other surface within the vehicle 106. In embodiments, the one or more processors 202 may generate an representation (e.g., an interactive graphical representation) of the example head unit 400 in addition to generating instructions for outputting or presenting the representation on a different surface in the interior of the vehicle 106.

For example, the one or more processors 202 may utilize the artificial intelligence neural network trained model described above to analyze the image data and generate instructions for outputting or presenting the example representation of the example head unit 400 such that the representation may appear as of an augmented or virtual reality based environment. In embodiments, the representation may appear to emerge from a back seat of the vehicle 106, an arm reset of the vehicle 106, a floor near the back seta of the vehicle 106, as part of physical devices that may be embedded within seats of the vehicle 106, door panels or doors near the rear seats of the vehicle 106, etc.

FIG. 4B depicts an example representation 408 of the example head unit 400 on a window 406 of the vehicle 106, according to one or more embodiments described and illustrated herein. Specifically, as illustrated, based on the generated instructions of the one or more processors 202, the example representation 408 may be presented, in real time, on the window 406 located adjacent to the seat in which the passenger 108 is seated. The example representation 408 may include all of the interactive icons output on the example head unit 400. For example, the example representation 408 may include multiple interactive icons which may, when interacted with, enable control of various vehicle functions such as vehicle climate control, activating and deactivating heated seats, navigation control, stereo control, and so forth. Specifically, the passenger 108 seated in the back seat of the vehicle 106 may be able to interact with each of the interactive icons included on the example representation 408 and control one or more of the vehicle functions listed above.

In embodiments, the passenger 108 may select an interactive icon corresponding to the climate control function by physically contacting the interactive icon displayed on the window 406, and input a desired temperature setting, e.g., in a text field that may appear upon selection of the interactive icon. The one or more sensors 208 may include a touch sensor that is configured to detect contact from the passenger 108. In some embodiments, the passenger 108 may select the interactive icon corresponding to the climate control function by directing the gaze of the passenger 108 at the interaction icon and resting the gaze at the icon for a predetermined time frame. In response, the one or more processors 202 may determine that the passenger 108 intends to control the climate inside the vehicle 106 and automatically display a text field in which a temperature setting may be input. In embodiments, the passenger 108 input a temperature value (e.g., by interacting with the text field with his fingers), which may be recognized by the one or more processors 202. In this way, a new temperature value may be set within the vehicle 106. In some embodiments, in response to the displayed text field, the passenger 108 may speak a temperature value, which may be recognized by the one or more processors 202, and as such, a new temperature value may be set within the vehicle 106. In this way, by either contacting each of the interactive icons with his or her hands or gazing at the interactive icons, the passenger 108 may control multiple vehicle functions within the vehicle 106.

In other embodiments, as stated above, the example representation 408 may be displayed or presented as part of a virtual or augmented reality environment such that the example representation 408 appears to emerge outwards from various surfaces within the vehicle 106, e.g., an arm rest, empty back seat, or floor of the vehicle 106. In embodiments, the example representation 408, after emerging from one or more of these surfaces, may appear at a certain height and within a certain arm's length of the passenger 108 such that the passenger may easily interact with one or more interactive icons included in the example representation 408. In embodiments, the example representation 408 emerging from the one or more surfaces may have dimensions that mirror the dimensions of the example head unit 400 positioned adjacent to the driver's seat. For example, the example representation 408 may appear directly in front of the passenger 108, e.g., within a direct line of sight of the passenger 108. Other such variations and locations are also contemplated. The passenger 108 may select each of the icons included in the example representation 408 by manually contacting one or more interactive icons included in the representation as part of the augmented or virtual reality interface or by gazing one or more interactive icons for a predetermined time frame.

FIG. 4C depicts an example representation 416 of the example head unit 400 on a mobile device 414 (e.g., an additional device in the form of a tablet, a smartphone, and so forth) of the passenger 108, according to one or more embodiments described and illustrated herein. Specifically, the one or more processors 202 may analyze the image data and determine that the passenger 108 has viewed specific interactive icons displayed on the example head unit 400. In response, the one or more processors 202 may generate instructions for presenting these specific interactive graphical icons as part of an example representation 416 on a display of a mobile device 414 of the passenger 108, and transmit these instructions, via the communication network 104, to the mobile device 414.

In embodiments, upon receiving the instructions, one or more processors of the mobile device 414 may output the example representation 416 on a display of the mobile device 414 in real time. The representation may appear on the display as a smaller version of the example head unit 400 and include all of the interactive icons included in the heat unit. In some embodiments, the representation may only include the specific interactive icons at which the passenger 108 may have directed his gaze for a predetermined time frame. Additionally, the passenger 108 may control one or more vehicle functions or operations (e.g., an additional operation) by manually selecting (e.g., additional input) one or more interactive icons output on the display of the mobile device 414 of the passenger 108.

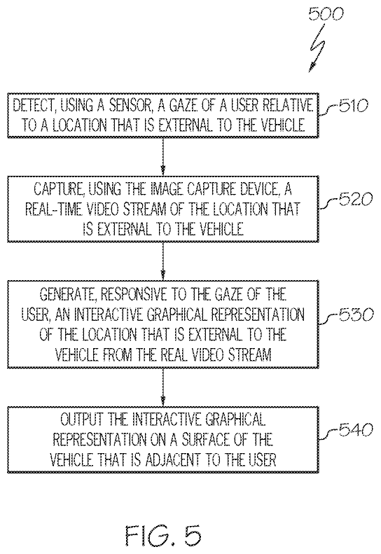

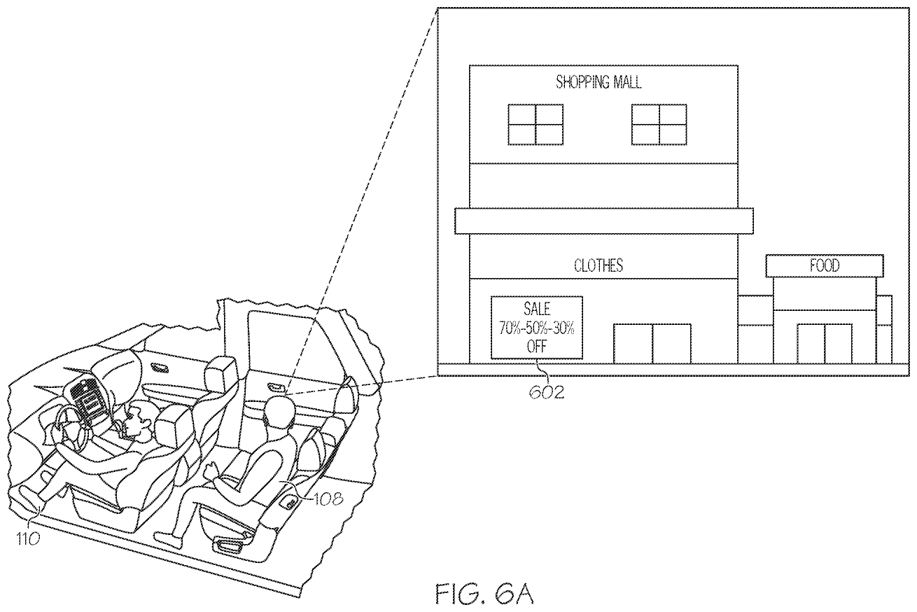

FIG. 5 depicts a flow chart 500 for presenting an representation of one or locations external to the vehicle 106 on a surface of the vehicle 106, according to one or more embodiments described herein.

At block 510, the representation presentation system may detect, using a sensor such as the outward facing camera 214, a gaze of the passenger 108 relative to a location that is external to the vehicle 106. In particular, the inward facing camera 216 may capture image data in the form of one or more images and/or a live video stream of the direction and orientation of the head of the passenger 108, eyes of the passenger 108, and so forth, and route the image data to the one or more processors 202 for analysis. Upon analyzing the image data, the one or more processors 202 may determine that the passenger 108 has directed his gaze to one or more locations that are external to the vehicle 106 and instruct the outward facing camera 214 to perform certain tasks, namely capture image data of the locations at which the passenger 108 may have directed his gaze.

At block 520, the one or more processors 202 may instruct the outward facing camera 214 to capture a real-time video stream of one or more locations that are external to the vehicle 106. In particular, based on the instructions, the outward facing camera 214 may capture image data of one or more locations at which the gaze of the passenger 108 may be directed, e.g., discount signs, names and addresses of various stores that are adjacent to and within a certain vicinity of the vehicle 106, and so forth.

At block 530, the one or more processors may generate, responsive to the gaze of the user (e.g., the passenger 108), an representation of the one or more locations that are external to the vehicle 106 from the live video stream that may be captured by the outward facing camera 214. The one or more locations may be locations at which the passenger 108 may have directed his gaze.

At block 540, the representation may be output on a surface of the vehicle 106 that is adjacent to the passenger 108. For example, the representation may be presented on the window 406 of the vehicle 106 or may appear as part of a virtual or augmented reality environment such that the representation may appear to morph from or emerge outwards from various surfaces within the vehicle 106, e.g., an arm rest, empty back seat, or floor of the vehicle 106. In embodiments, the representation, after emerging from one or more of these surfaces, may appear at a certain height and within a certain arm's length of the passenger 108.

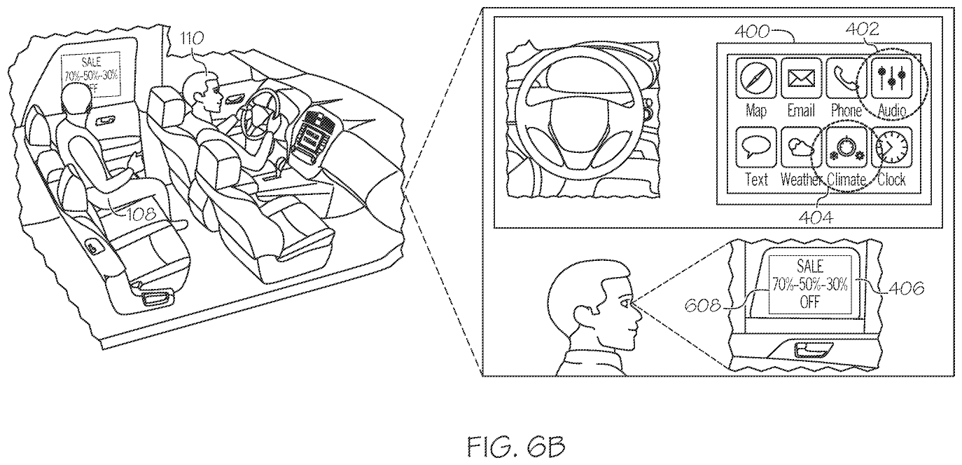

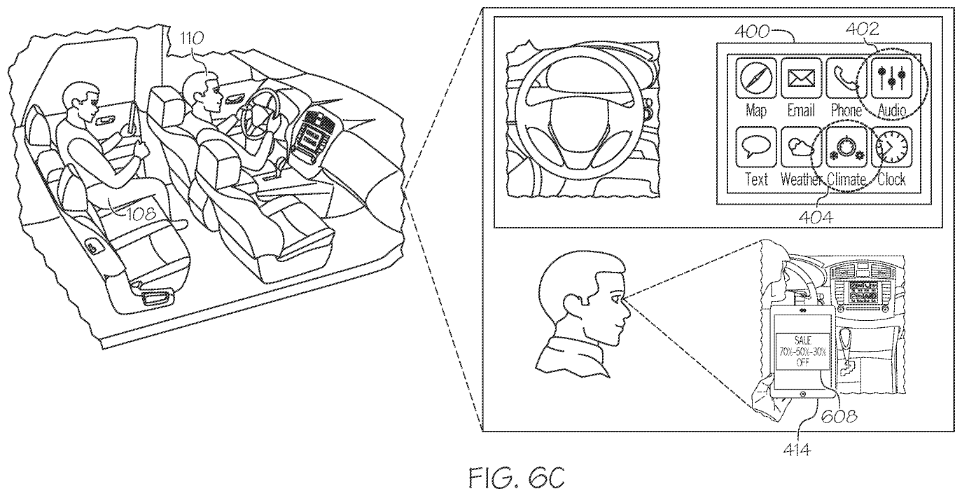

FIG. 6A depicts an example operation of the representation presentation system of the present disclosure in which an representation of a location exterior to the vehicle 106 may be presented on the window 406 of the vehicle 106, according to one or more embodiments described and illustrated herein. In embodiments, the passenger 108 may be seated in the back seat of the vehicle 106 and direct his gaze to one or more areas outside of the vehicle 106. For example, as the vehicle 106 travels along city street, the passenger 108 may direct his gaze towards various commercial shopping establishments located adjacent to the street. The inward facing camera 216 may track the movements of the head of the passenger 108 over a certain time frame, capture image data associated with these movements, and route this data to the one or more processors 202 for further analysis. The one or more processors 202 may analyze the image data, which includes identifying the angle of the head of the passenger 108, the orientation of the eyes of the passenger 108, and so forth, and determine that the passenger 108 is directing his gaze at one or more locations on the exterior of the vehicle 106.

In embodiments, based on this determination, the one or more processors 202 may instruct the outward facing camera 214 to capture image data in the form of a live video stream or one or more images of the one or more locations at which the gaze of the passenger 108 may be directed. Specifically, the outward facing camera 214 may capture a live video stream or one or more images of roadside shops and commercial establishments at which the passenger 108 may have directed his gaze. The one or more processors 202 may then analyze the captured image data and identify different types of subject matter included as part of the image data, e.g., discount sign 602, names and addresses of stores, etc. Upon identifying different types of subject matter, the one or more processors 202 may generate an representation of the location that is external to the vehicle 106, e.g., a representation of the discount sign 602 posted near a window or door of a commercial establishment.

FIG. 6B depicts an example representation 608 of an external location at which the passenger 108 may have gazed being presented on the window 406 of the vehicle 106, according to one or more embodiments described and illustrated herein. In particular, as illustrated in FIG. 6B, the example representation 608 may be presented on the window 406 adjacent to the seat at which the passenger 108 is seated. In embodiments, the example representation 608 may be an enlarged version of the live video stream of the one or more locations at which the passenger 108 may have directed his gaze, e.g., an enlarged digital image of the discount sign 602 located in an area that is external to the vehicle 106.

FIG. 6C depicts the example representation 608 of an external location at which the passenger 108 may have gazed being presented on the mobile device 414 of the passenger 108, according to one or more embodiments described and illustrated herein. Specifically, the one or more processors 202 may transmit instructions for presenting the example representation 608 on the display of the mobile device 414. The example representation 608 may be, e.g., an enlarged image of the one or more locations at which the passenger 108 may have directed his gaze. In embodiments, the passenger 108 may be able to select a portion of the representation 608 and further enlarge the representation in order to, e.g., better identify the discount amount in the discount sign 602.

It should be understood that the embodiments of the present disclosure are directed to a vehicle comprising a sensor, an additional sensor, a display, and a computing device that is communicatively coupled to the sensor, the additional sensor, and the display. The computing device is configured to: detect, using the sensor operating in conjunction with the computing device of the vehicle, an orientation of a part of a user relative to a location on the display that is positioned in an interior of the vehicle, detect, using the additional sensor, an interaction between the user and a portion of the display positioned in the interior of the vehicle, determine, using the computing device, whether a distance between the location and the portion of the display satisfies a threshold, and control, by the computing device, an operation associated with the vehicle responsive to determining that the distance between the location and the portion of the display satisfies the threshold.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method implemented by a computing device of a vehicle, the method comprising:
detecting, using a sensor operating in conjunction with the computing device of the vehicle, a gaze of a user relative to one or more input devices positioned in an interior of the vehicle; and
presenting a representation of the one or more input devices on a surface of the vehicle that is adjacent to the user.

2. The method of claim 1, wherein the representation includes interactive icons.

3. The method of claim 2, wherein each of the interactive icons corresponds to a respective one of the one or more input devices positioned in the interior of the vehicle.

4. The method of claim 1, wherein the user is positioned in a rear passenger seat of the vehicle.

5. The method of claim 1, wherein the one or more input devices are positioned on an additional surface of the vehicle, the additional surface is adjacent to a front seat of the vehicle.

6. The method of claim 4, wherein the surface of the vehicle that is adjacent to the user is located on a rear-passenger window adjacent to the rear passenger seat in which the user is positioned.

7. The method of claim 1, wherein the sensor is a camera.

8. The method of claim 1, further comprising detecting, using an additional sensor operating in conjunction with the computing device, an input from the user relative to the representation, the additional sensor is a touch sensor.

9. The method of claim 8, further comprising controlling, by the computing device, an operation associated with the vehicle responsive to the detecting of the input relative to the representation.

10. The method of claim 8, wherein the detecting of the input from the user relative to the representation corresponds to the user selecting an icon of a plurality of interactive icons included in the representation.

11. The method of claim 1, further comprising:
transmitting, by the computing device, instructions associated with the representation of the one or more input devices to an additional device that is external to the vehicle; and
presenting, based on the instructions, the representation on a display of the additional device that is external to the vehicle.

12. The method of claim 11, further comprising receiving, by the computing device, data associated with an additional input of the user associated with the representation that is output on the display of the additional device that is external to the vehicle.

13. The method of claim 12, further comprising controlling, by the computing device, an additional operation associated with the vehicle responsive to receiving the data associated with the additional input.

14. A vehicle comprising:
a sensor and; and
a computing device that is communicatively coupled to the sensor and the computing device is configured to:
detecting, using the sensor operating in conjunction with the computing device of the vehicle, a gaze of a user relative to one or more input devices positioned in an interior of the vehicle; and
presenting a representation of the one or more input devices on a surface of the vehicle that is adjacent to the user.

15. The vehicle of claim 14, wherein the representation includes interactive icons.

16. The vehicle of claim 15, wherein each of the interactive icons corresponds to a respective one of the one or more input devices positioned in the interior of the vehicle.

17. The vehicle of claim 14, wherein the surface of the vehicle that is adjacent to the user is located on a rear-passenger window adjacent to a rear passenger seat in which the user is positioned.

18. A vehicle comprising:
a sensor and an image capture device positioned on an exterior portion of the vehicle;
a computing device communicatively coupled to each of the sensor and the image capture device, the computing device is configured to:
detect, using the sensor, a gaze of a user relative to a location that is external to the vehicle;
capture, using the image capture device, a real-time video stream of the location that is external to the vehicle;
generate, responsive to the gaze of the user, a representation of the location that is external to the vehicle from the real-time video stream; and
present, on a surface of the vehicle that is adjacent to the user, the representation of the location that is included in the real-time video stream.

19. The vehicle of claim 18, wherein the computing device that is configured to present the representation of the location includes presenting an enlarged digital image of the location that is external to the vehicle.

20. The vehicle of claim 19, wherein the computing device that is configured to present the representation of the location includes presenting an enlarged version of the real-time video stream of the location that is external to the vehicle.
